(19) United States
(12) Patent Application Publication
(10) Pub. No.: US 2010/0144485 A1
(43) Pub. Date: Jun. 10, 2010

(54) Transmission

(76) Inventor: Martin Boudreau, St-Joachim de Courval (CA)

Correspondence Address: Louis Tessier, PO Box 54029, Town of Mount-Roval, QC, H3P 3H4, CA

(21) Appl. No.: 11/990,137

(22) PCT Filed: Aug. 3, 2006
(86) PCT No.: PCT/CA2006/001294

§ 371 Date: Feb. 7, 2008

(30) Foreign Application Priority Data
Aug. 9, 2005 (CA) 2,513,261
Sep. 29, 2005 (CA) 2,541,352

(51) Int. Cl. F16H 15/50; F16H 3/62

(52) U.S. Cl. 475/269

(57) ABSTRACT

A transmission (10) for converting an input rotational motion having an input angular speed into an output rotational motion having an output angular speed. The transmission (10) includes a transmission body (12); a first rotating component (14) rotatably mounted to the transmission body (12); a second rotating component (18) mounted to the transmission body (12) in a substantially parallel and spaced apart relationship relatively to the first rotating component (14); an output component (20) mounted to the transmission body (12) substantially concentrically relatively to the first and second rotating components (14) and (18), the output component (20) being rotatable about a rotation axis (16) at the output angular speed; a first coupling mechanism (22) operatively coupled to the first and second rotating components (14) and (18) such that a rotation of the first rotating component (14) causes a rotation of the second rotating component (18), the first coupling mechanism (22) being fixed relatively to the transmission body (12); a second coupling mechanism (24), the second coupling mechanism (24) including a substantially disc-shaped member (26, 38a) rotatably mounted to the output component substantially radially spaced apart from the rotation axis (16), the substantially disc-shaped member (26, 38a) being disposed between and engaged with the first and second rotating components (14) and (18). Rotating the first and second rotating components (14) and (18) produces a substantially circumferential movement of the disc-shaped member (26, 38a) relatively to the rotation axis, which causes a rotation of the output component (20) relatively to the transmission body (12); and at least one of the first and second coupling mechanisms (22) and (24) is a variable ratio mechanism allowing to selectively vary a ratio between the input angular speed and the output angular speed.

### FIELD OF THE INVENTION

The present invention relates to the field of power transmission. More specifically, the present invention is concerned with a transmission.

### BACKGROUND OF THE INVENTION

Transmissions are used to couple a power source such as, for example, a motor to an output member. To that effect, the transmission includes a transmission input rotating at an input angular speed and a transmission output rotating at an output angular speed. The transmission input is mechanically coupled to the power source and the transmission output is mechanically coupled to the output member.

Transmissions may perform many functions. For example, a transmission may convert the input angular speed to an output angular speed that differs from the input angular speed. One way of performing this conversion involves one or more gears disposed between the transmission input and output. However, converting an input angular speed to an output angular speed that differs greatly from the input angular speed requires typically the use of many interlinked gears. The use of interlinked gears typically decreases the power transmission efficiency of the transmission as each gear typically causes power losses of the order of a few percents.

Another manner of converting angular speeds includes using a hydraulic system for transmitting the power from the transmission input to the transmission output. By controlling the flow of fluid within such a hydraulic transmission, the ratio between the input and output angular speeds may be varied. However, hydraulic systems are typically relatively expensive to manufacture as they require relatively tight manufacturing tolerances and need to be relatively robust. In addition, hydraulic systems are typically relatively heavy, especially as compared to mechanical systems including gears.

Another function that may be performed using a transmission is to reverse a rotation direction. For example, the transmission may use an even number of gears located between the transmission input and output to convert a rotation in a first direction to a rotation in a second direction opposite the first direction. One disadvantage of doing a change in rotation direction in this manner is that a change in direction only occurs discretely. In other words, changing the direction of rotation as described hereinabove does not allow to reduce the output angular speed to zero and to subsequently increase the output angular speed in the opposite direction. Instead, using such a gear typically allows only to discretely change the rotation of a first speed in a first direction to a rotation in the same first speed but in the opposite direction. In addition, as mentioned hereinabove, the use of gears typically implies that there are relatively large power losses within the transmission.

In some cases, it is required that the transmission input be decoupled from the transmission output so that the transmission output may, for example, be stopped while the power source is kept running. This is, for example, the case in the automotive industry wherein it is required that the engine can keep on running while the vehicle in which the engine is provided is stopped. In the automotive industry, this is achieved in two different manners.

In the first manner, a transmission is provided between the wheels and the motor and clutch allows to selectively engage the transmission with the motor. Therefore, when the clutch is disengaged, the motor runs freely while the wheels of the vehicle may turn at any desired speed. In the other manner, power transmission is effected by a transmission using a viscous fluid transmitting the power between the transmission input and the transmission output. Since there is not direct mechanical link between the engine and the wheels, it is possible to stop the wheels, for example, using the brakes of a vehicle, while keeping the engine running. In this case, the engine simply creates a torque at the output of the transmission that is opposed by the brakes of the vehicle. However, these two manners of uncoupling the motor from the wheels are relatively complex and require that the components used to that effect be relatively robust and, therefore, relatively expensive to manufacture.

Against this background, there exists a need in the industry to provide a novel transmission. An object of the present invention is therefore to provide an improved transmission.

### SUMMARY OF THE INVENTION

In a broad aspect, the invention provides a transmission for converting an input rotational motion having an input angular speed into an output rotational motion having an output angular speed. The transmission includes:
a transmission body;
a first rotating component rotatably mounted to the transmission body, the first rotating component being rotatable at a first angular speed about a rotation axis;
a second rotating component mounted to said transmission body in a substantially parallel and spaced apart relationship relatively to the first rotating component, the second rotating component being rotatable about the rotation axis at a second angular speed;
an output component mounted to the transmission body substantially concentrically relatively to the first and second rotating components, the output component being rotatable about the rotation axis at the output angular speed;
a first coupling mechanism operatively coupled to the first and second rotating components such that a rotation of the first rotating component causes a rotation of the second rotating component, the first coupling mechanism being fixed relatively to the transmission body;
a second coupling mechanism, the second coupling mechanism including a substantially disc-shaped member rotatably mounted to the output component substantially radially spaced apart from the rotation axis, the substantially disc-shaped member being disposed between and engaged with the first and second rotating components;
wherein
   rotating the first and second rotating components produces a substantially circumferential movement of the disc-shaped member relatively to the rotation axis, which causes a rotation of the output component relatively to the frame; and
   at least one of the first and second coupling mechanisms is a variable ratio mechanism allowing to selectively vary a ratio between the first angular speed and the output angular speed.

Advantageously, the transmission is relatively easy and inexpensive to manufacture and relatively easy to use.

Furthermore, a transmission ratio between the input angular speed and the output angular speed may be varied over a relatively large interval without using complex gear systems.

In some embodiments of the invention, the variable ratio mechanism is of the continuously variable type such as, for example, of the toroidal type. In these embodiments, it is possible to continuously vary a ratio between the input angular speed and the output angular speed. In addition, in some embodiments of the invention, the ratio between the input and output angular speeds may go through zero and become negative continuously by varying the transmission ratio of the continuously variable mechanism.

In some embodiments of the invention, a lock allows to block the continuously variable mechanism at a fixed ratio of input to output angular speed.

In some embodiments of the invention, a brake allows to block the circumferential movement of the disc-shaped member relatively to the first and second members when the continuously variable transmission is in a configuration resulting in zero output speed. Therefore, this brake allows to ensure that the output speed remain fixed at zero, which could be difficult to achieve if only the continuous mechanism allowing to vary the transmission ratio were used to that effect.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a perspective cross-sectional view, illustrates a transmission in accordance with an embodiment of the present invention;

FIG. 2, in an exploded view, illustrates the transmission of FIG. 1;

FIG. 3, in a perspective view, illustrates a roller support of the transmission of FIG. 1 supporting traction rollers;

FIG. 4, in a perspective view, illustrates a roller support supporting traction rollers in accordance with an alternative embodiment of the present invention;

FIG. 5a, in perspective partial cross-sectional view, illustrates an actuator usable in the transmission of FIG. 1, the actuator being shown with an actuator handle thereof in an unlocked position;

FIG. 5b, in perspective partial cross-sectional view, illustrates the actuator of FIG. 5a, the actuator handle being shown in a locked position;

FIG. 5c, in perspective partial cross-sectional view, illustrates the actuator of FIG. 5a, the actuator handle being shown in the unlocked position;

FIG. 5d, in perspective partial cross-sectional view, illustrates the actuator of FIG. 5a, the actuator handle being shown in a brake engaging position;

FIG. 6, in a perspective cross-sectional view, illustrates a transmission in accordance with an alternative embodiment of the present invention;

FIG. 7, in an exploded view, illustrates the transmission of FIG. 6;

FIG. 8, in a perspective partial cross-sectional view, illustrates a roller support of the transmission of FIG. 6 supporting traction rollers;

FIG. 9, in a perspective view, illustrates a roller support of the transmission of FIG. 6 supporting traction rollers;

FIG. 10, in a perspective view, illustrates an actuator of the transmission of FIG. 6;

FIG. 11, in a partial perspective view, illustrates the actuator of the transmission of FIG. 6 with a brake thereof in a released configuration;

FIG. 12, in a partial perspective view, illustrates the actuator of the transmission of FIG. 6 with the brake thereof in an engaged configuration; and

FIG. 13, in a perspective partial cross-sectional view, illustrates a transmission in accordance with another alternative embodiment of the present invention.

### DETAILED DESCRIPTION

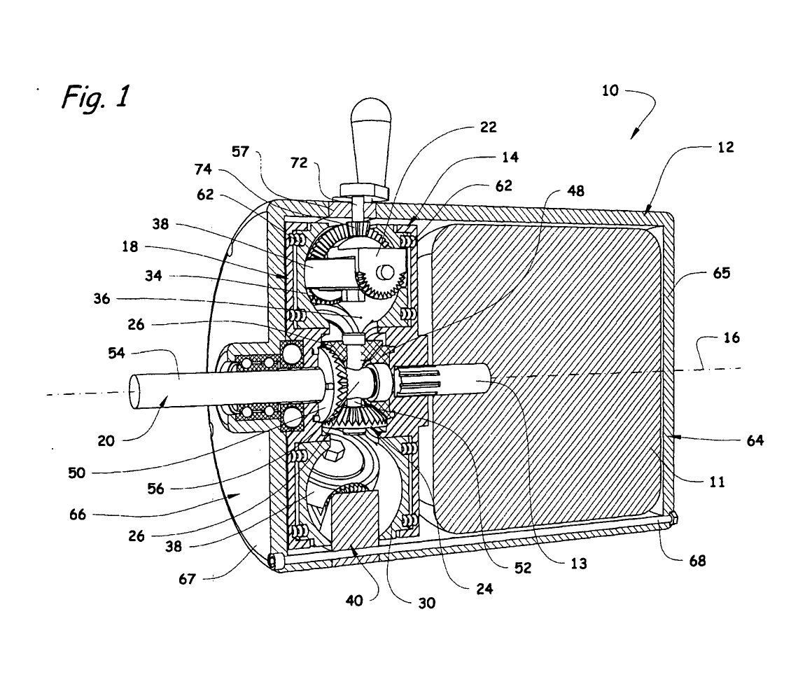

Referring to FIG. 1, there is shown a transmission 10 for converting an input rotation in motion having an input angular speed into an output rotation motion having an output angular speed. The transmission 10 includes a transmission body 12. A first rotating component 14 is rotatably mounted to the transmission body 12. The first rotating component 14 is rotatable at a first angular speed about a rotation axis 16.

A second rotating component 18 is mounted to the transmission body 12 in a substantially parallel and spaced apart relationship relatively to the first rotating component 14. The second rotating component 18 is rotatable about the rotation axis 16 at a second angular speed.

An output component 20 is mounted to the transmission body 12 substantially concentrically relatively to the first and second rotating components 14 and 18. The output component 20 is rotatable about the rotation axis 16 at the output angular speed.

A first coupling mechanism 22 is operatively coupled to the first and second rotating components 14 and 18 such that the rotation of the first rotating component 14 causes a rotation of the second rotating component 18. The first coupling mechanism 22 is fixed relatively to the transmission body 12.

A second coupling mechanism 24 is also provided. The second coupling mechanism 24 includes a substantially disc-shaped member such as, for example, a pinion gear 26, mounted to the output component 20 substantially radially spaced apart from the rotation axis 16. The substantially disc-shaped member 26 is disposed between and engaged with the first and second rotating components 14 and 18.

Rotating the first and second rotating components 14 and 18 produces a substantially circumferential movement of the disc-shaped member 26 relatively to the rotation axis 16. In turn, this causes a rotation of the output component 20 relatively to the transmission body 12.

The first coupling mechanism 22 is a variable ratio mechanism allowing to selectively vary a ratio between the first angular speed and the output speed. However, in alternative embodiments of the invention, the second coupling mechanism or both the first and the second coupling mechanisms are variable ratio mechanisms allowing to selectively vary a ratio between the first angular speed and the output speed.

In some embodiments of the invention, such as for example in the embodiments shown in the Figures, the variable ratio mechanism is a continuously variable ratio mechanism allowing to continuously vary the ratio between the output and input speeds. However, in alternative embodiments of the invention, the variable ratio mechanism is a discretely variable mechanism allowing to vary the ratio between the output and input speeds in discrete steps.

In some embodiments of the invention, the first rotating component 14 is coupled to a motor 11 through an input shaft 13. Therefore, the first rotating component 14 is rotated relatively to the transmission body 12 by the motor 11.

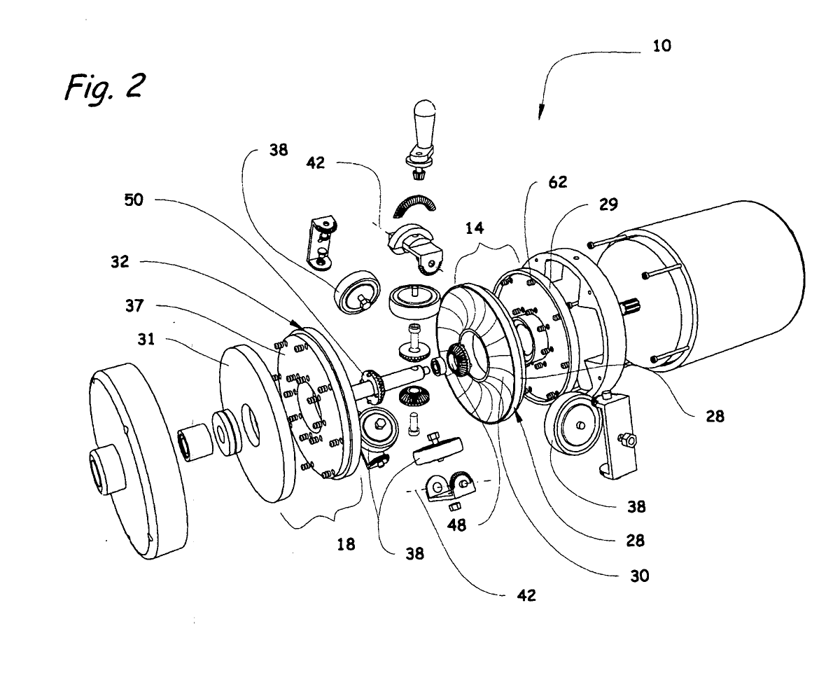

As better seen in FIG. 2, the first rotating component 14 includes a first component toric disc 28. The second rotating component 18 includes a second rotating component toric disc 32. The first and second rotating component toric discs 28 and 32 define a substantially annular space 36 therebetween (better seen in FIG. 1). To that effect, the first and second rotating component toric discs 28 and 32 each define respectively a first and second component grooves 30 and 34, the first and second component grooves 30 and 34 being substantially annular and having a substantially arc segment shaped cross-section.

Referring to FIG. 1, the first coupling mechanism 22 includes at least two motion transmitting traction rollers 38 located in the substantially annular space 36. The motion transmitting traction rollers 38 each engage the first and second rotating component toric discs 28 and 32.

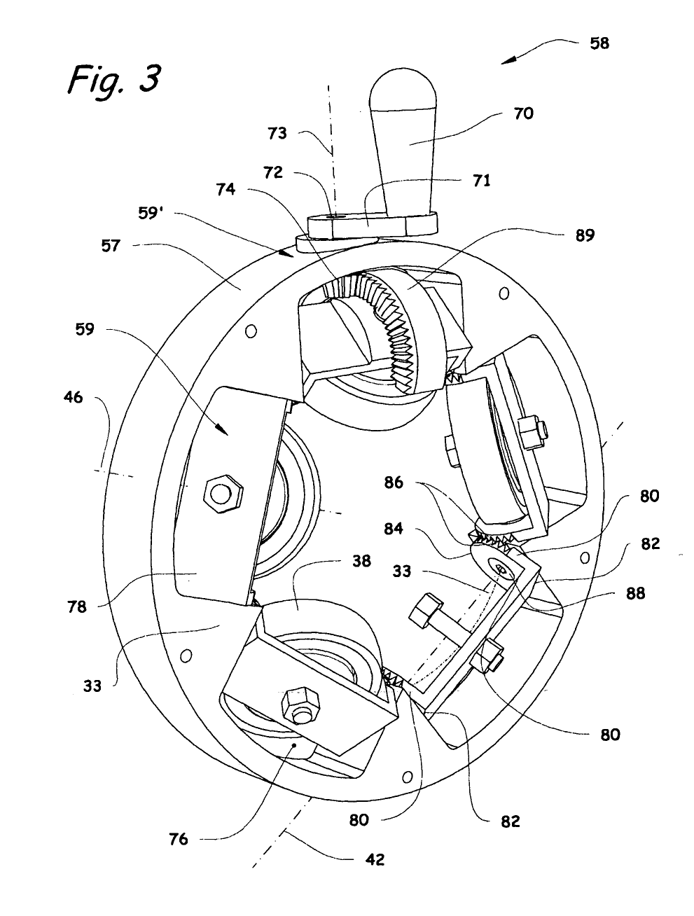

As better seen in FIG. 3, a roller support 40 supports the motion transmitting traction rollers 38. Each of the motion transmitting traction rollers 38 is pivotally mounted to the roller support 40 so as to be selectively pivotable about a respective roller pivot axis 42, only one of which is shown in FIG. 3. The roller pivot axes 42 are substantially tangential to and substantially co-planar with the circumference of a circle 33 extending substantially parallel to the first and second component toric discs 28 and 32.

Each of the traction rollers 38 is further rotatable about a respective roller rotation axis 46 substantially perpendicular to the roller pivot axis 42 about which the traction roller 38 is pivotable. While the transmission 10 includes five motion transmitting traction rollers 38, it is within the scope of the invention to have a transmission having any other suitable number of motion transmitting traction rollers 38.

Returning to FIG. 1, the first rotating component 14 includes a substantially annular first component face gear 48. The first component face gear 48 is substantially concentric relatively to the output component 20 and located radially inwardly relatively to the first component groove 30 and the motion transmitting traction rollers 38. The first component face gear 48 is operatively coupled to the first toric disc 28 such that the first component face gear 48 and the first toric disc 28 rotate jointly at the first angular speed.

The second rotating component 18 includes a substantially annular second component face gear 50. The second component face gear 50 is substantially concentric relatively to the output component 20 and located radially inwardly relatively to the second component groove 34 and the motion transmitting traction rollers 38. The second component face gear 50 is operatively coupled to the first toric disc 28 such that the second component face gear 50 and the second toric disc 32 rotate jointly at the first angular speed.

The first and second component face gears 48, 50 face each other and the pinion gear 26 engages both the first and second component face gears 48, 50. It should be noted that while the output member 20 extends through the second component face gear 50, all the second rotating component 18, including the second component face gear 50, is rotatable relatively to the output member 20.

Referring to FIG. 1, the pinion gear 26 is mounted to a pinion shaft 52. The pinion shaft 52 is operatively coupled to the output component 20 so that a substantially circumferential movement of the pinion gear 26 causes a rotation of the output component 20.

The transmission 10 shown in FIGS. 1 and 2 includes two pinion gears 26 each mounted to a respective pinion shaft 52. Each of the pinion shafts 52 is operatively coupled to the output component 20 so that a substantially circumferential movement of the pinion gears 26 causes a rotation of the output component 20. In alternative embodiments of the invention, a transmission similar to the transmission 10 includes any other suitable number of pinion gears.

The transmission 10 has been described generally hereinabove. Hereinbelow, a more detailed description of some components of the transmission 10 is found.

Referring to FIG. 1, in some embodiments of the invention, a biasing component 62 is operatively coupled to the transmission body 12 and to the first and second component toric discs 28 and 32 for biasing the first and second component toric discs 28 and 32 towards each other. For example, the biasing component 62 includes springs biasing the first and second component toric discs 28 and 32 towards each other.

The transmission body 12 includes a transmission body first section 64 and a transmission body second section 66. The transmission body first and second sections 64, 66 are each substantially cylindrical and include respectively a transmission body first end wall and a transmission body second end wall 65, 67. A support body 57 of the roller support 40 is inserted between the transmission body first and second sections 64 and 66. The transmission body first section 64, the transmission body second section 66 and the support body 57 are secured to each other so as to form an enclosure using transmission body fasteners 68. For example, the transmission body fasteners 68 include a nut and a bolt, thereby allowing to access the interior of the transmission 10 for maintenance, repairs or other purposes relatively easily.

Referring to FIG. 2, in some embodiments of the invention, the first and second component toric discs 28 and 32 respectively include a first toric disc base 29 and a second toric disc base 31. The first and second toric disc bases 29 and 31 are rotatably mounted inside the transmission body 12 and each receive respectively a first and a second toric component 35 and 37. The first and second toric components 35 and 37 are mounted facing each other between the first and second component toric disc bases 29 and 33. The springs forming the biasing element 62 are provided between the first component toric disc base 29 and the first toric component 35 and between the second component toric disc base 31 and the second toric component 35. However, in alternative embodiments of the invention, the first and second component toric discs 28 and 32 may take any other suitable configuration.

The output component 20 includes an output shaft 54 extending through the second rotating component 18. The output shaft 54 includes a pinion coupling portion 56 located between the first and second component toric discs 28 and 32. The pinion shafts 52 are mechanically coupled to the pinion coupling portion 56.

Referring to FIG. 3, the roller support 40 includes a substantially annular support body 57 and at least two roller holders 59, each receiving a respective motion transmitting traction roller 38. Each of the roller holders 59 is pivotally mounted to the support body 57 so as to be selectively pivotable about a respective one of the roller pivot axes 42. In some embodiments of the invention, the roller holders 59 are operatively coupled to each other so as to be jointly pivotable about their respective roller pivot axes 42.

The transmission 10 includes an actuator 58 operatively coupled to the roller holders 59 for selectively pivoting the roller holders 59 about their respective roller pivot axes 42. The actuator 58 includes an actuator axle 72 to which is mounted an actuator gear 74. The actuator gear 74 is rotatable about an actuator rotation axle 73 extending substantially radially outwardly using an actuator handle 70 that is mounted eccentrically relatively to the actuator axle 72 through a handle mounting component 71. The actuator axle 72 extends through the roller support 40 and the actuator gear 74 is located substantially adjacent the roller holder 59, as described in further details hereinbelow.

The support body 57 defines roller holder receiving recesses 76. Each of the roller holder receiving recesses 76 receives a respective roller holder 59. For example, each roller holder 59 includes a roller holder base 78 and two roller holder arms 80 extending substantially perpendicularly therefrom in a spaced apart relationship relatively to each other. Therefore the roller holders 59 are substantially U-shaped.

Each of the roller holder arm 80 defines an arm first end 82 located substantially adjacent the roller holder base 78 and an opposed arm second end 84 located distally relatively to the roller holder base 78. The arm second ends 84 are substantially arc segment shaped.

Arm teeth 86 are provided substantially adjacent the arm second ends 84. The roller holders 59 and the support body 57 are configured and sized so that the arm teeth 86 of adjacent roller holders 54 engage each other. Therefore, pivoting one of the roller holders 59 causes the other roller holders to pivot substantially similarly. The reader skilled in the art will readily appreciate that the roller holders 59 may be operatively coupled to each other so that pivoting one of the roller holders 59 causes the other roller holders 59 to pivot in any other suitable manner.

A traction roller axle 88 is affixed to each of the roller holder bases 78 and extends substantially radially inwardly therefrom. The traction holder axles 88 each rotatably receive one of the motion transmitting traction rollers 38 so that the motion transmitting traction rollers 38 are substantially parallel to the roller holder base 78.

One the roller holders 59′ located substantially adjacent the actuator gear 74 includes a roller holder gear 88. The roller holder gear 88 is substantially annular and extends substantially perpendicularly to the actuator gear 74 and to the circle 33. The roller holder gear 88 engages the actuator gear 74 so that a rotation of the actuator gear 74 results in the roller holders 59 pivoting about their respective roller pivot axis 42.

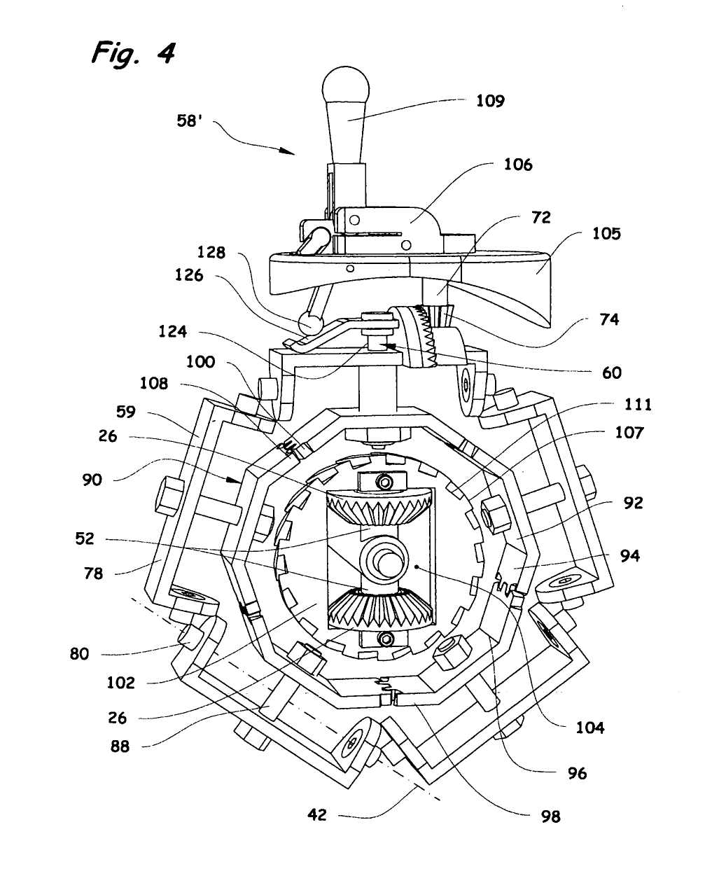

In some embodiments of the invention, for example in the embodiment shown in FIG. 4 and described in further details hereinbelow, the actuator 58 includes a lock. The lock is operable between a locked configuration and an unlocked configuration. In the locked configuration, the lock prevents the roller holders 59 from rotating about their respective holder pivot axes 42. In the unlocked configuration, the lock allows the rotation of the roller holders 59 about their respective holder pivot axes 42.

In some embodiments of the invention, the actuator 58 includes a brake 60 operable between an engaged configuration and a released configuration. The brake 60 is operatively coupled to the pinion gear 26 for preventing a rotation of the pinion gear 26 when the brake 60 is in the engaged configuration. When the brake 60 is in the released configuration, a rotation of the pinion gear 26 is allowed.

FIG. 4 illustrates an alternative embodiment of the invention wherein the roller holders 59′ are coupled to each other so as to be jointly rotatable about their respective roller pivot axes 42 in an alternative manner. Instead of having arm teeth 86 formed at the end of roller holder arms, the roller holders 59′ shown in FIG. 4 each include a respective roller holder coupling member 90 located substantially opposed to the roller holder base 78 relatively to the traction rollers 38. Alternative roller holder arms 80′ which do not include teeth extend from the roller holder base 78 similarly to the roller holder arms 80.

Each of the roller holder coupling member 90 is secured to the traction roller axle 88 and includes a holder coupling member base 92 substantially parallel to the roller holder base 78. Two holder coupling member arms 94 extend substantially outwardly respectively from both ends of each holder coupling member base 92. Each of the coupling member arms 94 includes a coupling member arm first end 96 located substantially adjacent the holder coupling member base 92 and a coupling arm second end 98 located distally relatively to the holder coupling member 92.

Coupling arm teeth 100 and form substantially into each coupling member arms 94 substantially adjacent the coupling arm second ends 98. The coupling arm teeth 100 of adjacent roller holders 59′ engage each other so that pivoting one of the roller holders 59′ relatively to its respective roller pivot axis 42 results in all the roller holders 59′ pivoting jointly about their respective holder pivot axes 42 by substantially the same angle.

Also, as shown in FIG. 4, in some embodiments of the invention, the pinion gears 26 are supported by a pinion support 102. Pinion support 102 is substantially annular and defines a pinion support passageway 104 extending substantially longitudinally therethrough. The pinion gears 26 and the pinion shafts 52 are supported within the pinion support passageway 104.

The pinion support 102 further defines a pinion support circumferential surface 107. The pinion support circumferential surface 107 includes pinion support grooves 111 extending substantially longitudinally and transversely radially thereinto. In other words, the pinion support grooves 111 extend helicoidally relatively to the longitudinal axis 16. The pinion support grooves 111 are usable for stopping a rotation of the pinion gears 26 relatively to the support body 12, thereby providing a brake for preventing the output member 20 from rotating. The pinion support grooves 111 extend substantially obliquely onto the pinion support circumferential surface 107 relatively to the longitudinal axis 16 of the transmission 10.

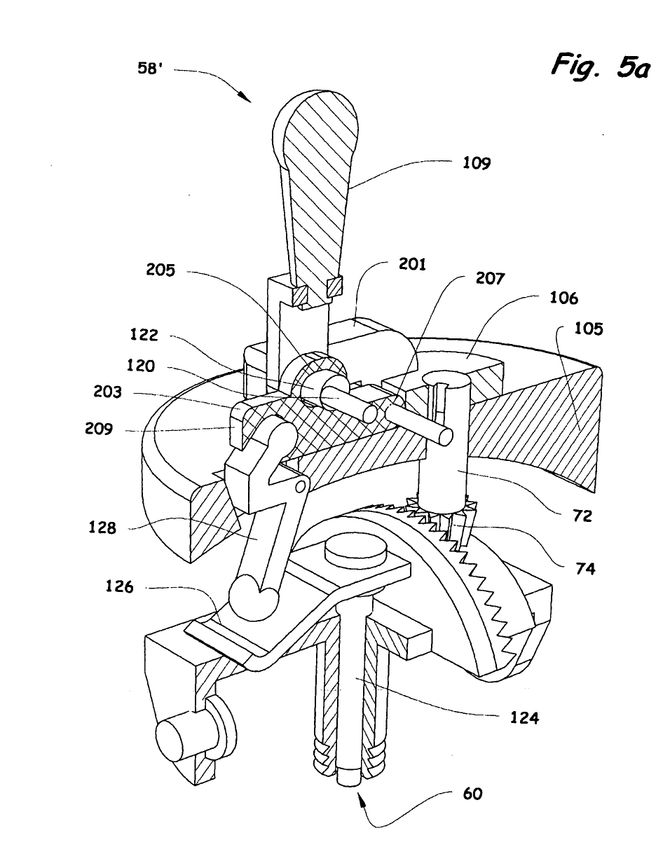

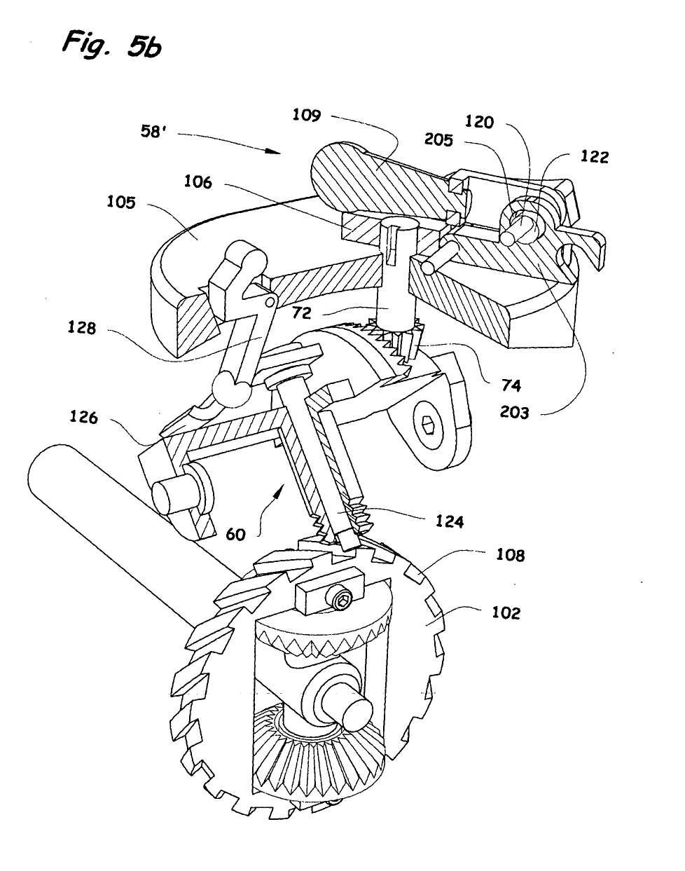

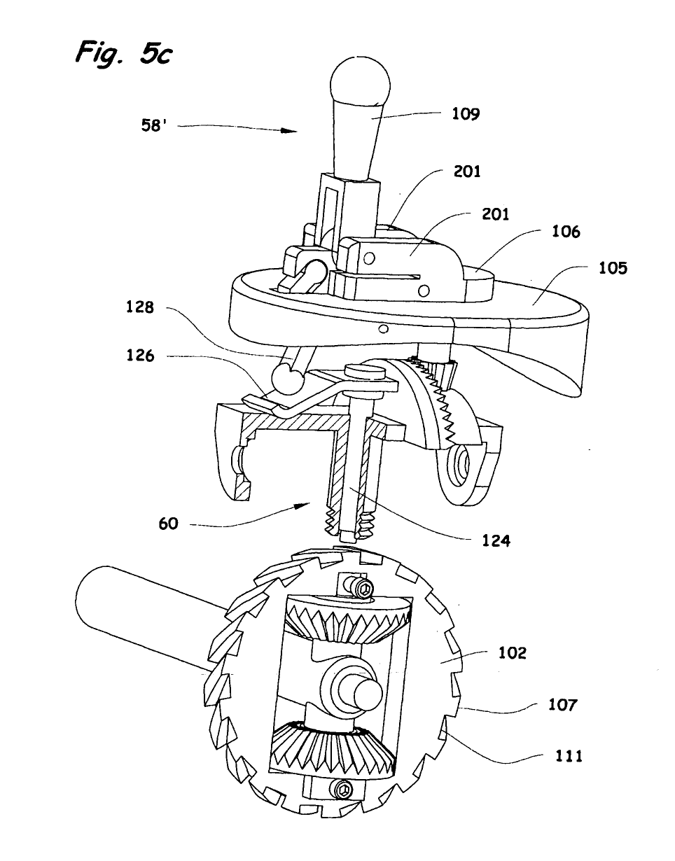

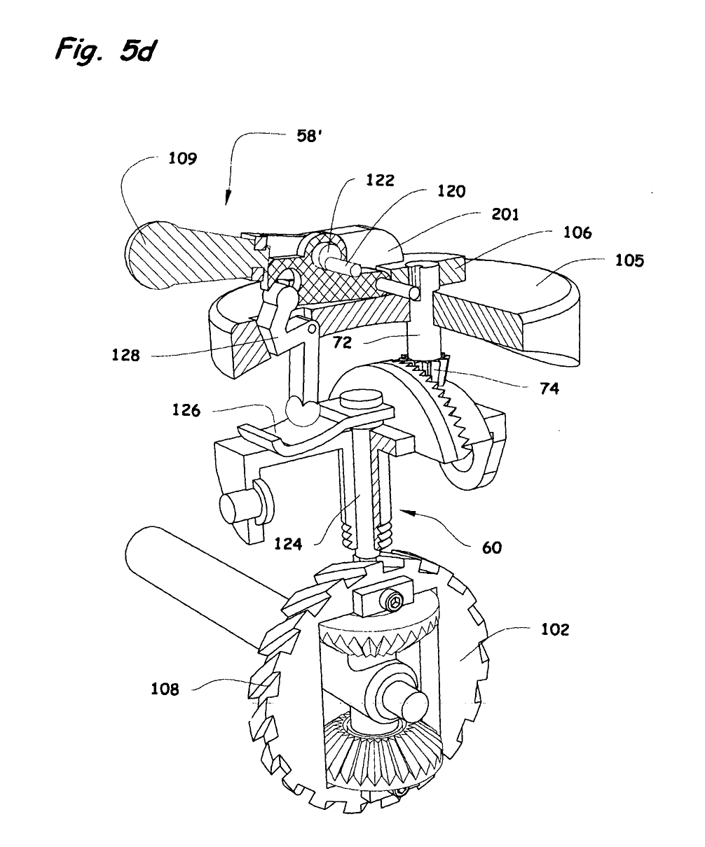

FIG. 4 also illustrates an alternative actuator 58′. The actuator 58′ is similar to the actuator 58 except that it includes an actuator lock and actuates the brake 60. To that effect, as better seen in FIG. 5a, the actuator 58′ includes the actuator gear 74 and the actuator axle 72. The actuator axle 72 extends through an actuator base 105, which is securable to the transmission body 12, and is coupled to an actuator body 106 including an actuator handle 109 mounted eccentrically relatively to the actuator axle 72. An actuator body 106 is located opposite the actuator gear 74 relatively to the actuator axle 72. The actuator axle 72 is operatively coupled to the actuator handle 109 such that rotating the actuator handle 109 about the actuator axle 72 rotates the actuator gear 74.

In opposition to the actuator 58, the actuator handle 109 is not fixed relatively to the actuator body 106 but is mounted so as to be pivotable about an axis substantially perpendicular to the rotation axis of the actuator gear 72 in a plane substantially perpendicular to the actuator body 106 passing through the actuator axle.

To that effect, referring to FIG. 5a, the actuator body 106 includes an actuator body handle support such as, for example, a fork including two support arms 201, only one of which is seen in FIG. 5a. The support arms 201 are substantially parallel to each other and in a spaced apart relationship relatively to each other.

The handle 109 and a brake engaging member 203 are mounted to the support arms 201. The brake engaging member 203 is substantially elongated and defines a substantially elongated engaging member-to-handle coupling aperture 205. The brake engaging member 203 defines an engaging member first end 207 and a substantially longitudinally opposed engaging member second end 209. The brake engaging member 203 is pivotally mounted to the support arms 201 substantially adjacent the engaging member first end 207 so as to be pivotable in a plane substantially parallel to a plane in which the handle 109 is pivotable. The engaging member-to-handle coupling aperture 205 is substantially longitudinally elongated.

A handle support axle 120 extends between the support arms 201. A handle support cylinder 122 is mounted substantially eccentrically to the handle support axle 120. The handle support cylinder 122 extends through the engaging member-to-handle coupling aperture 205. The handle support axle 120 is operatively coupled to the actuator handle 198 such that a rotation of the actuator handle 109 results in the handle support cylinder 122 rotating within the engaging member-to-handle coupling aperture 205.

The brake engaging member 203 allows to lock the actuator handle 109 so as to prevent a rotation of the roller holders 59 relatively to their respective roller pivot axes 46.

In some embodiments of the invention, a brake rod 124 extends substantially radially into the transmission body 12. The brake rod 124 extends through the roller holder 59′ located substantially in register with the actuator 58′ so as to be substantially radially movable relatively thereto. The brake rod 124 is coupled to a biasing element 126 biasing the brake rod 124 substantially away from the pinion support grooves 104. A brake actuating component 128 is operatively coupled to the biasing element 126 for selectively moving at least a portion of the brake biasing element 126 towards the pinion gears 26 so as to move brake rod 124 into one of the pinion support grooves 111.

In this configuration, called the engaged configuration, the brake rod 124 engages the pinion support grooves 111 so as to prevent the pinion support 102 from rotating. For example, this movement of the brake biasing element 126 is provided through the brake actuating component 128 operatively coupled to the actuator handle 109 such that pivoting the actuator handle 109 towards the brake actuating component 128 causes the brake rod 124 to be biased towards the pinion support 102.

The actuator handle 109 is movable between a locked position, shown in FIG. 5b, an unlocked position, shown in FIGS. 5a and 5c, and a brake actuating position shown in FIG. 5d. In the locked position, the handle 109 extends substantially towards the actuator axle 72 and biases the engaging member second end 209 towards the actuator base 105 as the cylinder 122 rotates within the aperture 120. The brake engaging member 203 then frictionally engages the actuator base 105 and therefore locks the actuator handle 109 so that the actuator gear 74 does not rotate.

In the unlocked position, the brake engaging member 203 is spaced apart from the actuator base 105 and the handle extends substantially radially outwardly. In this position, the brake rod 124 is spaced apart from the pinion support grooves 104 which, therefore, allows the pinion support 108 to rotate about the rotation axis 16 in response to the pinion gears 26 rotating relative to the first and second face gears. The brake 60 is therefore in the released configuration.

In the brake actuating position, the actuator handle 109 extends substantially away from the actuator axle 72 and moves the brake actuating component 128 so as to bias the brake rod 124 towards the pinion support 102 so that the brake 60 achieves an engaged configuration. If the brake rod 124 is not aligned with one of the pinion support groove 108, any slight motion of the pinion support 102 caused by small deviation from an exact parallel configuration of the traction rollers 59 will cause the pinion support 102 to rotate such that one of the pinion support grooves 111 is substantially in register with the brake rod 124. The brake rod 124 will, therefore, be able to engage the pinion support groove 108.

It should be noted that the pinion support grooves 111 are oriented such that a rotation of the pinion support 102 in a given direction will cause an opposite effect on the traction rollers resulting in a compensation of this movement of the pinion support 102. Then, relatively small mechanical constraints are present in the actuator brake 60 and the pinion support 102.

In use, the motor 12 rotates the first rotating component 14 at a first angular speed. This causes the first component toric disc 28 and the first component face gear 48 to both rotate at the first angular speed. This rotational motion is transmitted to the second rotating component 18 through the motion transmitting traction rollers 38, which causes the second rotating component 18 to rotate at the second angular speed. This causes the second component face gear 50 and the second component toric disc 32 rotate at the second angular speed. The movement of the second coupling mechanism 24 and of the output component 20 depends on the orientation of the motion transmitting traction rollers 38.

When the motion transmitting traction rollers 38 are such that they engage the first and second component toric discs 28 and 32 at a substantially similar radial distance from the rotation axis 16, the first and second component face gears 48 and 50 rotate at the same absolute angular speed but in opposite directions. This causes the pinion gears 26 to rotate about the pinion shafts 52 but to remain circumferentially fixed relatively to the transmission body 12. Therefore, in this configuration, shown in FIG. 1, the output member 20 is not rotating.

If the motion transmitting traction rollers 38 are pivoted about their roller pivot axes using the actuator 58, 58′, the output component will rotate either in the same direction as the input shaft 13 or in an opposite direction to the input shaft 13, depending on the orientation of the motion transmitting traction rollers 38.

First, the situation in which the motion transmitting traction rollers 38 are pivoted such that a radial distance between the rotation axis 16 and the contact point between the motion transmitting traction rollers 38 and the first component toric disc 28 is smaller than a radial distance between the rotation axis 16 and the motion transmitting traction rollers 38 at a location at which they contact the second component toric disc 32 is considered. In this case, when the motion transmitting traction rollers 38 rotate 360 degrees about their respective roller rotation axes 46, the first rotating component 14 rotates over a larger angle than the second rotating component 18 since the motion transmitting traction rollers 38 are circumferentially fixed relatively to the transmission body 12. Also, the first rotating component 14 rotates in a direction opposite to a direction in which the second rotating component 18 rotates.

Therefore, the second face gear 50 will rotate in a direction opposed to the rotation of the first face gear 48 at a lower angular speed than the first face gear 50. In turn, the pinion gears 26 have a circumferential motion in the same direction as the input shaft 13. Finally, this will cause the output member 20 to rotate in the same direction as the input shaft 13, but at a lower angular speed.

In the opposite case, the second component face gear 50 is rotated with in the same direction as the first component face gear 48 and at an absolute angular speed that is larger than the angular speed of the first component face gear 48, which will result in the circumferential motion of the pinion gears 26 to be in opposite direction to the rotational direction of the input shaft 13, which will therefore cause the output component 20 to rotate in opposite direction to the input shaft 13.

Therefore, the transmission 10 allows to selectively rotate the output member 20 in the same direction as the input shaft 13, rotate the output member 20 in opposite direction to the input shaft 13 or to stop the rotation of the output member 20.

Pivoting the motion transmitting traction rollers 38 about the roller pivot axes 42 is performed by moving the actuator handle 109 so as to cause the actuator gear 74 to rotate. As the actuator gear 74 rotates, it moves the roller holders 59, 59′ with which it is engaged. In turn, this causes all the roller holders 59, 59′ to pivot to substantially the same angle.

The transmission 10 therefore allows to couple the motor 11 to the output member 20 to allow the output member to rotate in two directions and to be stably stopped while the motor 11 is powered at a substantially constant speed. Of course, the motor may also be operated at a variable speed without departing from the scope of the invention. Also, a ratio between the input speed and the output speed is continuously variable. Furthermore, in the transmission 10, the maximal speed of rotation of the output member 20 in one specific direction is larger than the maximal speed of rotation of the output member 20 in a direction opposed to one specific direction for a predetermined input speed. This is desirable in many applications, for example for vehicles which are typically operated at faster speed when going in a forward going direction than when going in a rearward direction.

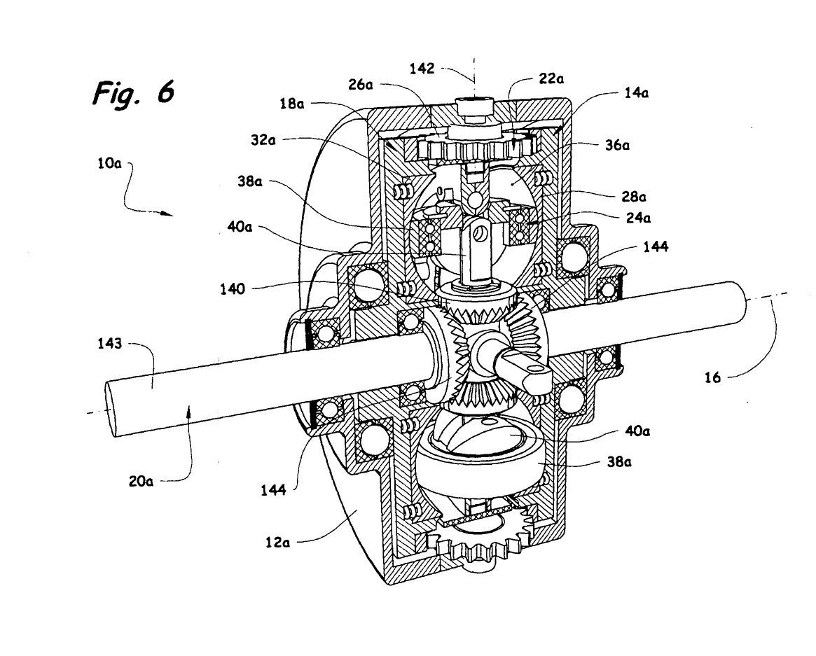

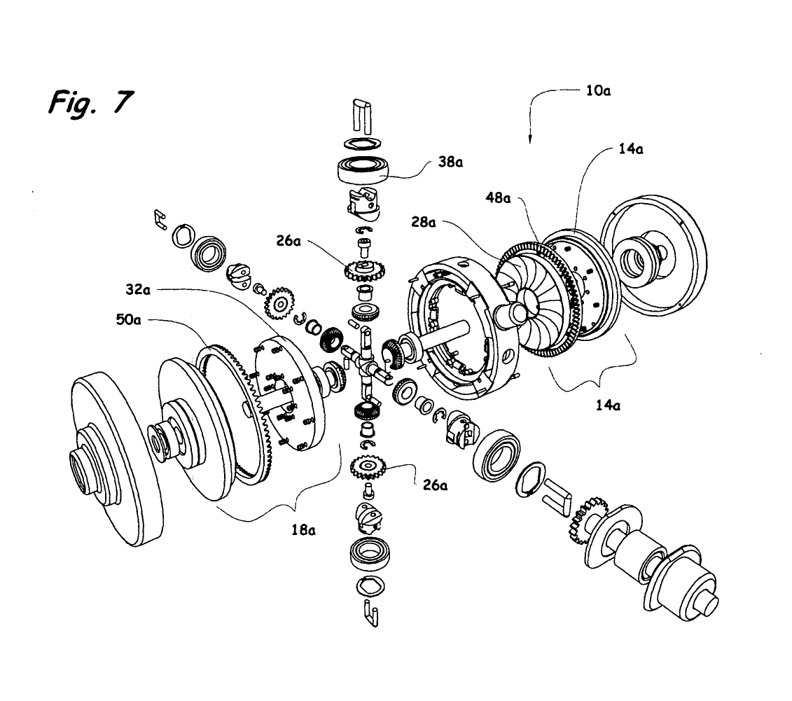

FIGS. 6 and 7 illustrate an alternative transmission 10a. The transmission 10a differs from the transmission 10 in that it is the second coupling mechanism 24a that is a variable ratio mechanism allowing to selectively vary a ratio between the first angular speed and the output angular speed.

To that effect, the transmission 10a includes a first rotating component 14a, the first rotating component 14a including a first component toric disc 28a. Also, the transmission 10a includes a second rotating component 18a, the second rotating component 18a including a second rotating component toric disc 32a. The first and second rotating component toric discs 28a and 32a define a substantially annular space 36a therebetween. The first and second component toric discs 28a and 32a are substantially similar to the first and second component toric discs 28 and 32 of the transmission 10 shown in FIGS. 1 through 5D. Therefore, the first and second component toric discs 28a and 32a will not be described in further details.

The second coupling mechanism 24a includes at least two motion transmitting traction rollers 38a located in the substantially annular space 36a. The motion transmitting traction rollers 38a each engage the first and second rotating component toric discs 28a and 32a.

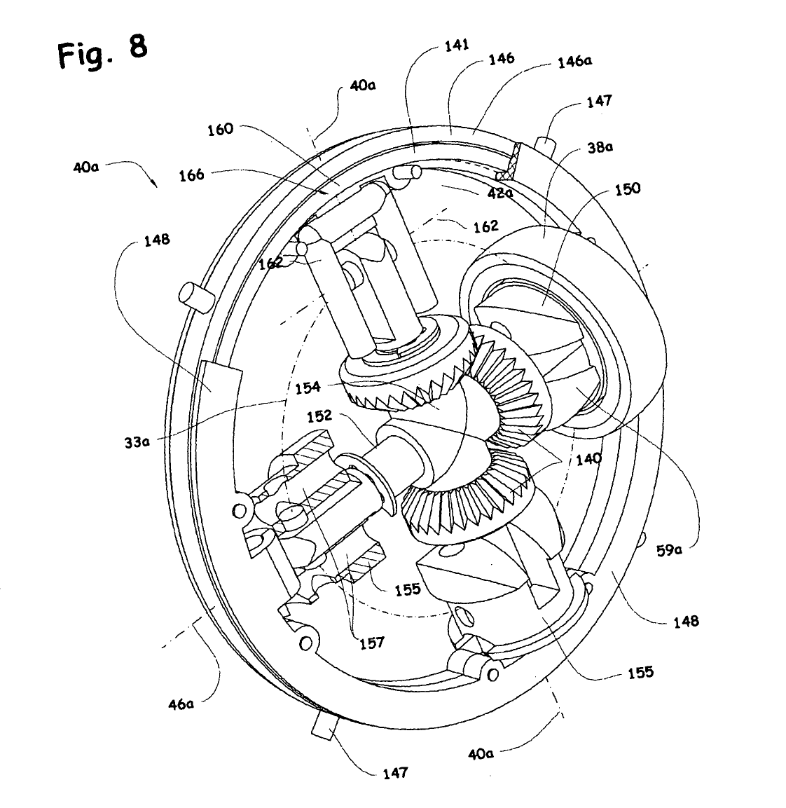

Referring to FIG. 8, a roller support 40a supports each of the motion transmitting traction rollers 38a. Each of the motion transmitting traction rollers 38a is pivotally mounted to the roller support 40a so as to be selectively pivotable about a respective roller pivot axis 42a. The roller pivot axis 42a is substantially tangential to and substantially co-planar with the circumference of a circle 33a extending substantially parallel to the first and second rotating component toric discs 28a and 32a. Each of the traction rollers 38a is further rotatable about a respective roller rotation axis 46a, each roller rotation axis 46a being substantially perpendicular to a respective one of the roller pivot axes 42a.

The roller supports 40a are movable substantially circumferentially relatively around the transmission rotation axis 16 relatively to the transmission body 12a. The roller supports 40a are operatively coupled to an output component 20a so that the substantially circumferential movement of the motion transmitting traction rollers 38a causes a rotation of the output component 20a.

As better seen in FIG. 7, the first rotating component 14a includes a substantially annular first component gear 48a. The first component gear 48a is substantially concentric relatively to the output component 20a. The first component gear 48a is located radially outwardly relatively to the motion transmitting traction rollers 38a.

The second rotating component 18a includes a substantially annular second component gear 50a. The second component gear 50a is substantially concentric relatively to the output component 20a. The second component gear 50a is located radially outwardly relatively to the motion transmitting traction rollers 38a.

A first coupling mechanism 22a, seen in FIG. 6, engages the first and second component gears 48a and 50a so that the rotation of the first rotating component 48a causes a rotation of a second component 48a. For example, the first coupling mechanism 28a includes a pinion gear 26a engaging both first and second component gears 48a and 50a.

In some embodiments of the invention, the first coupling mechanism 22a includes at least two pinion gears 26a each engaging both said first and second component gears 48a and 50a. One of the at least two pinion gears 26a is usable for tapping an output rotational motion. The other one of the at least two pinion gears 26a is rotatable by a power input. When the two pinion gears 26a have substantially the same number of teeth, the two pinion gears 26a rotate at the same angular speed. Therefore, the pinion gear 26a usable for tapping an output rotational motion effectively taps into a rotational motion having the same rotation speed as the other pinion gear through which power is input into the transmission 10a.

However, in alternative embodiments of the invention, power is input into the transmission 10a in any other suitable manner. For example, it is within the scope of the invention to rotate the first input component 14a relatively to the transmission body 12a using a motor, similarly to the embodiment of the invention shown in FIG. 1.

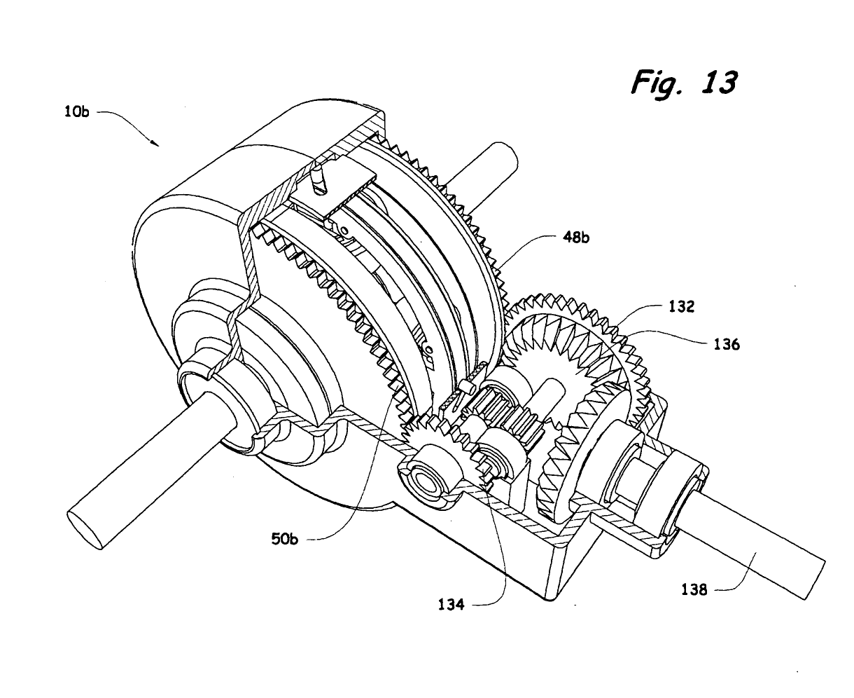

In other embodiments of the invention, for example in the transmission 10b shown in FIG. 13, the first coupling mechanism 22b includes a coupling mechanism input 138 for receiving an input rotational motion and two output gears 132 and 134 each engaging a respective one of a first and a second component gears 48b and 50b. The first coupling mechanism 22b is configured such that the first and second output gears 132 and 134 rotate first and second component gears 48b and 50b such that the first and second rotation speeds differ from each other. This may be achieved, for example, using a gear train 136 interposed between the coupling mechanism input 138 and the two output gears 132 and 134.

As better seen in FIG. 8, the roller support 40a includes a substantially annular support body 141. The roller support 40a includes at least two roller holders 59a each receiving a respective motion transmitting traction roller 38a. Each of the roller holders 59a is pivotally mounted to the support body 141 so as to be selectively pivotable about a respective one of the roller pivot axes 42a. The roller holders 59a are operatively coupled to each other so as to be jointly pivotable about their respective roller pivot axes 42a.

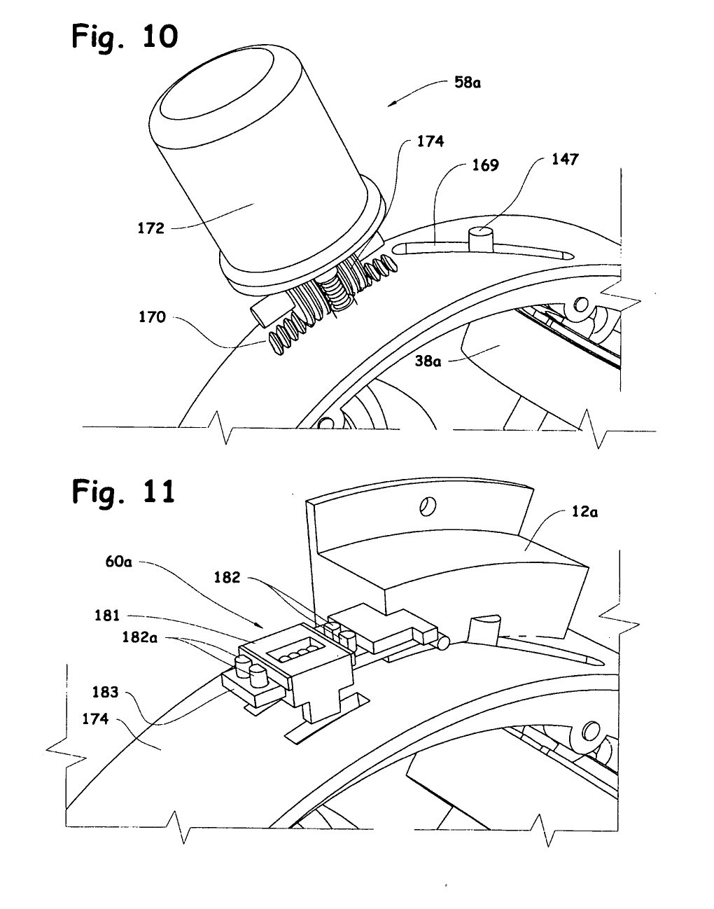

As seen in FIG. 10, an actuator 58a is operatively coupled to the roller holders 59a for selectively pivoting the roller holders 58a about their respective roller pivot axes 42a. The actuator 58a is described in further details hereinbelow.

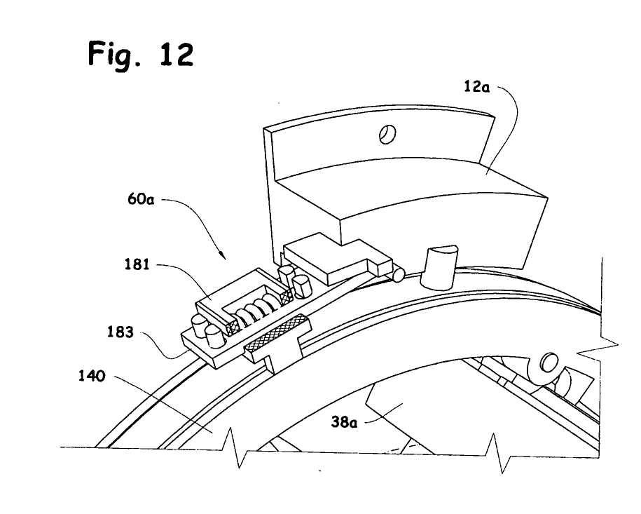

In some embodiments of the invention, the actuator 58a includes a brake 60a, operable between an engaged configuration, seen in FIG. 12, and a released configuration, seen in FIG. 11.

The brake 60a is operatively coupled to the roller supports 59a for preventing a substantially circumferential movement of the motion transmitting traction rollers 38a when the brake 60a is in the engaged configuration. When the brake 60a is in the released configuration, the substantially circumferential movement of the motion transmitting traction rollers 38a is allowed.

Referring to FIG. 6, in some embodiments of the invention, the second coupling mechanism 24a includes at least two output pinions 140. Each of the output pinions 140 is rotatable about a respective output pinion rotation axis 142 extending substantially radially. The output pinions 140 are located between the first and second rotating components 14a and 18a. The output pinions 140 are operatively coupled to the motion transmitting traction rollers 38a so that upon the traction rollers 38a moving circumferentially relatively to the transmission body 12a, the output pinions 140 rotate circumferentially relatively to the transmission body 12a.

The output component 20a includes two output shafts 143 rotatably mounted to the transmission body 12a. The output shafts 143 are operatively coupled to the output pinions 140 so that a circumferential movement of the output pinions 140 causes the output shafts 143 to differentially rotate relative to the transmission body. In other words, the output pinions 140 and the output shafts 143 form a differential having a power input at the output pinions 140.

To that effect, each of the output shafts 143 extends through a respective one of the first and second rotating components 14a and 18a. Each of the output shafts 143 supports an output shafts gear 144 located at one end thereof. The output shaft gears 144 each engage the output pinions 140. Each of the output shafts 143 is independently rotatable relatively to the transmission body 12a and relatively to the first and second rotating components 14a and 18a.

The transmission 10a has been described generally hereinabove. Hereinbelow, a non-limiting specific embodiment of the transmission 10a is described in further details. The reader skilled in the art will readily appreciate that many of the details described hereinbelow may be implemented in many alternative manners without departing from the scope of the present invention as defined in the appended claims.

FIG. 8 shows the support body 141 and the support holders 59a. The support body 141 includes a support body fixed member 146 from which support body pins 147 extend substantially radially outwardly. The support body fixed member 146 is fixed as it does no rotate circumferentially freely about the transmission rotation axis 16. The support body 141 further includes a support body rotatable element 148 mounted to the support body fixed member 146 so as to be rotatable about the transmission rotation axis 16.

The roller holders 59a are secured to the support body 141. The roller holders include a roller holder body 150 for receiving the motion transmitting traction rollers 38a. The roller holders bodies 150 are each mechanically coupled to a roller holder shaft 152 extending substantially radially inwardly towards the rotation axis 16a. The roller holder shafts 152 are all mechanically coupled to a support central member 154. Each of the roller holder shafts 152 supports a respective one of the output pinions. The output pinions 140 are mounted to the roller holder shafts so as to be rotatable freely about their respective output pinions rotation axes 142.

Each of the roller supports 59a includes a roller pivotable component 166 pivotally mounted to the support body rotatable element 148 so as to be pivotable in a substantially longitudinally and radially extending plane. Roller support-to-roller body connecting components 155 interconnect the motion transmitting traction rollers 38a to the roller body 140.

To that effect, each of the roller pivotable component 166 includes two connecting component radial members 162 extending substantially radially inwardly from a respective connecting component circumferential member 160. The connecting component circumferential member 160 is coupled to the support body 141 so as to be rotatable about an axis extending substantially tangentially to the circumference of the support body 141. The connecting component radial members 162 each engage a respective roller support-to-roller body connecting components 155 so as to be slidable relatively thereto. To that effect, each of roller support-to-roller body connecting components 155 defines two roller body passageways 157 extending substantially radially relatively thereto.

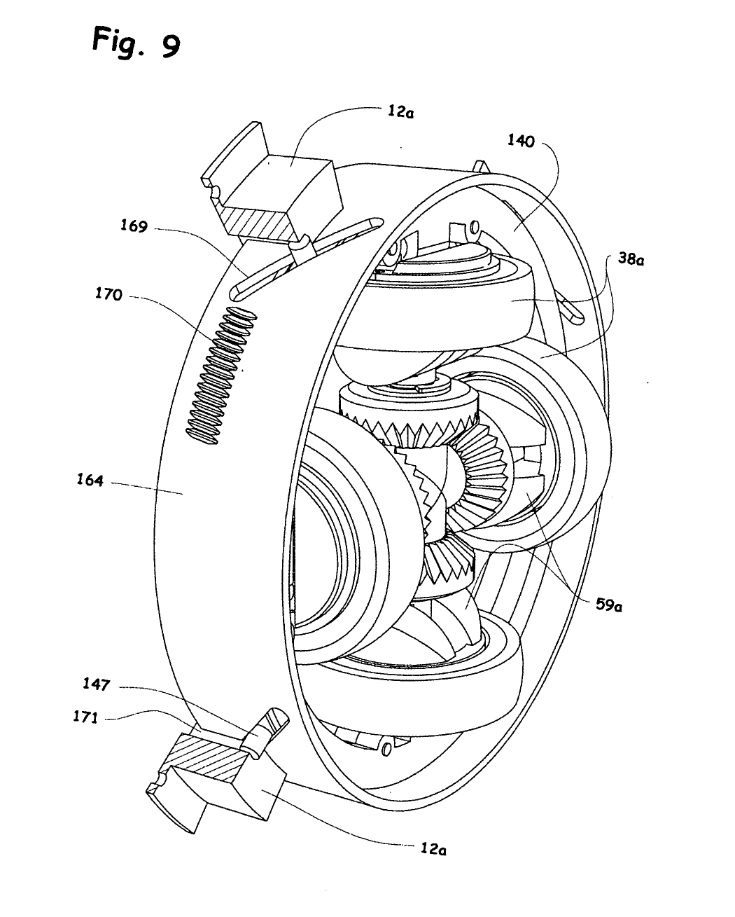

Referring to FIG. 9, the support body 141 is supported by a substantially annular support outer member 164. The support outer member 164 defines support outer member grooves 169 extending substantially helicoidally respectively to the transmission body 12a. In other words, the support outer member grooves 169 extend substantially longitudinally and substantially circumferentially relatively to the transmission body 12a. The support outer member grooves 169 each receive a respective one of the support body pins 147.

Body guiding grooves 171 are provided into the transmission body 12a substantially in register with each support body pin 147 and extend substantially radially outwardly from the transmission body inner surface towards the transmission body outer surface. The body guiding grooves extend substantially longitudinally and therefore restrain a movement of the support body pins 147 in the longitudinal direction. Also, as shown in FIG. 10, a worm gear 170 extends substantially circumferentially onto the support outer member 164.

Referring to FIG. 11, the actuator 58a includes an actuator motor 172 such as, for example, an actuator electrical motor that is controllable using a conventional controller. The actuator motor 172 is coupled to at least one actuator output groove 174 engaging the worm gear 170. The actuator output groove 174 and the worm gear 170 are substantially parallel relatively to each other. Therefore, rotating the actuator output groove 174 results in the worm gear 172 to move substantially circumferentially relatively to the actuator motor 172.

In some embodiments of the invention, the actuator 58a includes a brake 60a. The brake 60a is operable between the engaged configuration and the released configuration. Referring to FIG. 11, wherein the brake 60a is shown in the released configuration, the brake 60a includes a brake mobile member 181 slidably mounted onto a brake body 183. Electrical contacts 182a and 182b extend from the brake body 183 circumferentially spaced apart from each other. The brake mobile member 181 is mounted so as to be slidable between the electrical contacts 182a and 182b.

The brake body 183 is pivotally mounted to the transmission body 12a so as to be mobile between a mobile member disengaged position and a mobile member engaged position. In the mobile member disengaged position, the brake mobile member 181 is uncoupled from the support body 141 and the brake 60a is in the released configuration, as seen in FIG. 11. In the brake engaged configuration, the brake mobile member 181 extends through brake grooves 180 formed into the support body outer member 174 and engages the support body 141, as shown in FIG. 12. The brake mobile member 181 frictionally engages the support body 141 so as to move relatively to the brake grooves 180 when the motion transmitting traction rollers 38a move circumferentially relatively to the transmission body 12.

The electrical contacts 182a and 182b are operatively coupled to the actuator motor 172 so as to cause the motion transmitting traction rollers 38a to be pivoted about their holders pivot axes 42a in a direction leading the motion transmitting traction rollers 38a to move in a direction opposite to the direction in which the brake mobile member 181 has moved to reach one of the respective one of the electrical contacts 182a and 182b. Therefore, the electrical contacts 182a and 182b cause a movement opposite to any perturbation that may occur to the support body 141. It should be noted that the brake 60a may only be in the engaged configuration when the traction rollers 38a are such that they engage the first and second rotating components 14a and 18a at a substantially similar radial distance from the transmission rotation axis 16a. Indeed, it is only in this configuration that the traction rollers 38a do not move circumferentially relatively to the transmission body 12a and in which the brake 60a is required.

In use, pivoting the motion transmitting traction rollers 38a relatively to the holder pivot axis 42a causes the motion transmitting traction rollers 38a to engage the first and second rotating components 14a and 18a at different radial distances. This causes the motion transmitting traction rollers 38a to move circumferentially relatively to the transmission body 12a, similarly to the way in which the pinion gears 26 move circumferentially relatively to the first and second rotating components 14 and 18 in the transmission 10.

It should be noted that in the transmission 10a, the rotational angular speed of the first and second rotating components is fixed and that it is by varying the inclination of the motion transmitting traction rollers 38a that the rotational speed of the output shafts 142 is changed. The output shafts 142 are mounted in a differential arrangement such that the average of the rotation speed of the two output shafts 142 is equal to the speed to which the motion transmitting traction rollers 38a move circumferentially relatively to the transmission body 12a.

As seen from FIG. 11, when the actuator motor 172 is actuated, the support outer member 164 moves substantially circumferentially. In turn, this causes the support body pins 147 to move substantially circumferentially and therefore to move substantially longitudinally as they are constrained to move within the support outer member grooves 169. Therefore, this causes the support body 141 to move substantially longitudinally which, in turn, causes the motion transmitting traction rollers 38a to pivot about the roller supports pivot axes.

The reader skilled in the art will readily appreciate that components that are rotatably mounted relatively to other components may be mounted relatively to each other in any suitable manner such as, for example, using bearing or bushings.

Although the present invention has been described hereinabove by way of preferred embodiments thereof, it can be modified, without departing from the spirit and nature of the subject invention as defined in the appended claims.

What is claimed is:

1. A transmission for converting an input rotational motion having an input angular speed into an output rotational motion having an output angular speed, said transmission comprising:
a transmission body;
a first rotating component rotatably mounted to said transmission body, said first rotating component being rotatable at a first angular speed about a transmission rotation axis;
a second rotating component mounted to said transmission body in a substantially parallel and spaced apart relationship relatively to said first rotating component, said second rotating component being rotatable about said transmission rotation axis at a second angular speed;
an output component mounted to said transmission body substantially concentrically relatively to said first and second rotating component s, said output component being rotatable about said transmission rotation axis at the output angular speed;
a first coupling mechanism operatively coupled to said first and second rotating components such that a rotation of said first rotating component causes a rotation of said second rotating component, said first coupling mechanism being fixed relatively to said transmission body;
a second coupling mechanism, said second coupling mechanism including a substantially disc-shaped member rotatably mounted to said output component substantially radially spaced apart from said rotation axis, said substantially disc-shaped member being disposed between and engaged with said first and second rotating components;
wherein
rotating said first and second rotating components produces a substantially circumferential movement of said disc-shaped member relatively to said rotation axis, which causes a rotation of said output component relatively to said transmission body; and
at least one of said first and second coupling mechanisms is a variable ratio mechanism allowing to selectively vary a ratio between said first angular speed and said output angular speed.

2. A transmission as defined in claim 1, wherein:
said first rotating component includes a first rotating component toric disc;
said second rotating component includes a second rotating component toric disc;
said first and second rotating component toric discs define a substantially annular space therebetween;
said first coupling mechanism includes
at least two motion transmitting traction rollers located in said substantially annular space, said motion transmitting traction rollers each engaging said first and second rotating component toric discs;
a roller support supporting said motion transmitting traction rollers, each of said motion transmitting traction rollers being pivotally mounted to said roller support so as to be selectively pivotable about a respective roller pivot axis, said roller pivot axis being substantially tangential to and substantially coplanar with the circumference of a circle extending substantially parallel to said first and second rotating component toric discs, each of said traction rollers being further rotatably about a roller rotation axis substantially perpendicular to said roller pivot axis.

3. A transmission as defined in claim 2, wherein
said first rotating component includes a substantially annular first component face gear, said first component face gear being substantially concentric relatively to said output component, said first component face gear being located radially inwardly relatively to said motion transmitting traction rollers, said first component face gear being operatively coupled to said first toric disc such that said first component face gear and said first toric disc rotate jointly at said first angular speed;
said second rotating component includes a substantially annular second component face gear, said second component face gear being substantially concentric relatively to said output component, said second component face gear being located radially inwardly relatively to said motion transmitting traction rollers, said second component face gear being operatively coupled to said second toric disc such that said second component face gear and said second toric disc rotate jointly at said second angular speed;
said first and second component face gears are facing each other; and
said disc-shaped member is a pinion gear engaging both said first and second component face gear.

4. A transmission as defined in claim 3, wherein said pinion gear is mounted to a pinion shaft, said pinion shaft being operatively coupled to said output component so that a substantially circumferential movement of said pinion gear causes a rotation of said output component.

5. A transmission as defined in claim 4, wherein said second coupling mechanism includes at least two pinion gears each mounted to a respective pinion shaft, each of said pinion shafts being operatively coupled to said output component so that a substantially circumferential movement of said pinion gears causes a rotation of said output component.

6. A transmission as defined in claim 5, wherein said output component includes an output shaft extending through said second rotating component, said output shaft including a pinion coupling portion located between said first and second rotating component toric discs, said pinion shafts being mechanically coupled to said pinion coupling portion.

7. A transmission as defined in claim 3, wherein said roller support includes a substantially annular support body and at least two roller holders each receiving a respective motion transmitting traction roller, each of said roller holders being pivotally mounted to said support body so as to be selectively pivotable about a respective one of said roller pivot axes.

8. A transmission as defined in claim 7, wherein said roller holders are operatively coupled to each other so as to be jointly pivotable about their respective roller pivot axes.

9. A transmission as defined in claim 8, further comprising an actuator operatively coupled to said roller holders for selectively pivoting said roller holders about their respective roller pivot axes.

10. A transmission as defined in claim 9, wherein said actuator includes a lock, said lock being operable between a locked configuration and an unlocked configuration, wherein in said locked configuration, said lock prevents said roller holders from rotating about their respective holder pivot axes, and in said unlocked configuration, said lock allows a rotation of said roller holders about their respective holder pivot axes.

11. A transmission as defined in claim 9, wherein said actuator includes a brake operable between an engaged configuration and a released configuration, said brake being operatively coupled to said pinion gear for preventing a rotation of said pinion gear when said brake is in said engaged configuration and for allowing a rotation of said pinion gear when said brake is in said released configuration.

12. A transmission as defined in claim 2, further comprising a biasing component operatively coupled to said transmission body and to said first and second component toric discs for biasing said first and second component toric discs towards each other.

13. A transmission as defined in claim 1,
said first rotating component includes a first rotating component toric disc;
said second rotating component includes a second rotating component toric disc;
said first and second rotating component toric discs define a substantially annular space therebetween;
said second coupling mechanism includes
at least two motion transmitting traction rollers located in said substantially annular space, said motion transmitting traction rollers each engaging said first and second rotating component toric discs;
a roller support supporting said motion transmitting traction rollers, each of said motion transmitting traction rollers being pivotally mounted to said roller support so as to be selectively pivotable about a respective roller pivot axis, said roller pivot axis being substantially tangential to and substantially coplanar with the circumference of a circle extending substantially parallel to said first and second rotating component toric discs, each of said traction rollers being further rotatable about a respective roller rotation axis substantially perpendicular to a respective one of said roller pivot axes, said roller support being rotatable about said transmission rotation axis relatively to said transmission body so as to allow a circumferential movement of said motion transmitting traction rollers, said roller support being operatively coupled to said output component so that a substantially circumferential movement of said motion transmitting traction rollers causes a rotation of said output component.

14. A transmission as defined in claim 13, wherein
said first rotating component includes a substantially annular first component gear, said first component gear being substantially concentric relatively to said output component, said first component gear being located radially outwardly relatively to said motion transmitting traction rollers;
said second rotating component includes a substantially annular second component gear, said second component gear being substantially concentric relatively to said output component, said second component face being located radially outwardly relatively to said motion transmitting traction rollers;
said first coupling mechanism engages said first and second component gears so that a rotation of said first rotating component causes a rotation of said second component.

15. A transmission as defined in claim 14, wherein said first coupling mechanism includes a pinion gear engaging both said first and second component gears.

16. A transmission as defined in claim 15, wherein said first coupling mechanism includes at least two pinion gears each engaging both said first and second component gears, one of said at least two pinion gears being rotatable by a power input and another one of said at least two pinion gears being usable for tapping an output rotational motion.

17. A transmission as defined in claim 14, wherein said first coupling mechanism includes a coupling mechanism input for receiving the input rotational motion and two output gears each engaging a respective one of said first and second component gears, said first coupling mechanism being configured such that said first and second output gears rotate said first and second component gears such that said first and second rotation speeds differ from each other.

18. A transmission as defined in claim 13, wherein said roller support includes a substantially annular support body and at least two roller holders each receiving a respective motion transmitting traction roller, each of said roller holders being pivotally mounted to said support body so as to be selectively pivotable about a respective one of said roller pivot axes, said roller holders are operatively coupled to each other so as to be jointly pivotable about their respective roller pivot axes.

19. A transmission as defined in claim 18, further comprising an actuator operatively coupled to said roller holders for selectively pivoting said roller holders about their respective roller pivot axes.

20. A transmission as defined in claim 19, wherein said actuator includes a brake operable between an engaged configuration and a released configuration, said brake being operatively coupled to said roller support for preventing substantially circumferential movement of said motion transmitting traction rollers when said brake is in said engaged configuration and for allowing a substantially circumferential movement of said motion transmitting traction rollers when said brake is in said released configuration.

21. A transmission as defined in claim 13, further comprising a biasing component operatively coupled to said transmission body and to said first and second component toric discs for biasing said first and second component toric discs towards each other.

22. A transmission as defined in claim 13, wherein
said second coupling mechanism includes at least two output pinions, each of said output pinion being rotatable about a respective output pinion rotation axis extending substantially radially, said output pinions being located between said first and second rotating components, said output pinions being operatively coupled to said motion transmitting traction rollers so that upon said traction rollers moving circumferentially relatively to said transmission body, said output pinions rotate circumferentially relatively to said transmission body;
said output component includes two output shafts rotatably mounted to said transmission body, said two output shafts being operatively coupled to said output pinions such that a circumferential movement of said output pinions causes said output shafts to differentially rotate relatively to said transmission body.
